(19) United States
(12) Patent Application Publication
(10) Pub. No.: US 2020/0223406 A1
(43) Pub. Date: Jul. 16, 2020

(54) SCOOTER BRAKING SYSTEM AND METHOD

(71) Applicant: Honda Motor Co., Ltd., Tokyo (JP)

(72) Inventor: Shigeyuki SEKO, Campbell, CA (US)

(21) Appl. No.: 16/249,596

(22) Filed: Jan. 16, 2019

(51) Int. Cl. B60T 7/22; B62K 3/00; B62L 3/00

(52) U.S. Cl. CPC B60T 7/22; B62K 3/002; B62L 3/00; B62K 2207/00; B60T 2210/20; B60T 2201/022; B62K 2202/00; B60T 2210/32

(57) ABSTRACT

A scooter for providing transportation along a road includes a front wheel, a rear wheel, a footboard extending longitudinally between the front wheel and the rear wheel, an upright steering handle attached to the front wheel, a motor for driving the rear wheel, a battery located beneath the footboard for supplying electricity to the motor, an electromagnetic brake for slowing rotation of the rear wheel, a first sensor for detecting an obstacle in the road, and a second sensor for detecting vibrations of the scooter along the road. A method of actuating the brake system includes collecting data from the first sensor, collecting data from the second sensor, calculating a road condition factor from the data, determining whether the road condition factor exceeds a threshold level, and actuating the braking system to slow the scooter if the threshold level is exceeded.

### TECHNICAL FIELD

The embodiments described herein are related to personal scooters, and more specifically the braking system of self-propelled scooters.

### BACKGROUND

Scooters, sometimes called kick scooters or push scooters, have become more popular to both children and urban commuters as a method of travel. Scooters traditionally include a handlebar, a footboard, and front and rear wheels that are propelled by the rider pushing off the road.

Further, the scooter may be motorized. Motorized scooters may be powered by a gasoline engine or by an electric motor. A self-propelled scooter may be capable of speeds up to 30 km/h (19 mph). A braking system may also be applied in order to slow the scooter, particularly from the higher speeds capable with the application of the electric motor.

As scooters begin to operate at higher speeds, a need has been identified to slow the scooters if obstacles are located in front of scooters, particularly in areas where the riders may not be attuned to the all of the surroundings in front of them.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a scooter for providing transportation along a road includes a front wheel, a rear wheel, a footboard extending longitudinally between the front wheel and the rear wheel, an upright steering handle attached to the front wheel, a motor for driving the rear wheel, a battery located beneath the footboard for supplying electricity to the motor, an electromagnetic brake for slowing rotation of the rear wheel, a first sensor for detecting an obstacle in the road, and a second sensor for detecting vibrations of the scooter along the road.

According to another aspect, a method of actuating a braking system of a scooter traveling on a road includes measuring a first distance from a first sensor to a specified location in the road forward of the scooter, measuring a vertical displacement of the scooter due to a condition of the road beneath the scooter using a second sensor, comparing the first distance to an expected distance defining a distance to a flat portion of a road forward of the scooter, correcting the first distance based upon the vertical displacement of the scooter, calculating a road condition factor, wherein the road condition factor is the difference between the first distance and the expected distance, determining whether the road condition factor exceeds a threshold level, wherein the threshold level is a predetermined measure plus or minus the expected distance, and actuating the braking system to slow the scooter if the threshold level is exceeded.

According to yet another aspect, a method of actuating a braking system of a scooter traveling on a road includes collecting data from a first sensor, collecting data from a second sensor, calculating a road condition factor from data collected from the first sensor and the second sensor, determining whether the road condition factor exceeds a threshold level, and actuating the braking system to slow the scooter if the threshold level is exceeded.

### BRIEF DESCRIPTION OF THE DRAWINGS

FIG. 1 is a perspective view of a scooter with a rider.

FIG. 2 is a side view of a first embodiment of a scooter with a chain driven wheel.

FIG. 3 is a side view of a second embodiment of a scooter with a hub motor driven wheel.

FIG. 4 is an embodiment of a scooter on a flat road with an obstacle in the road.

FIG. 5 is an embodiment of the scooter on a bumpy road with an obstacle in the road.

FIG. 6 is a schematic view of a processor for controlling a braking system of the scooter.

FIG. 7 is a graphical representation of a road condition calculation between two predetermined thresholds.

FIG. 8 is a flowchart depicting a method of controlling the braking system of the scooter.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

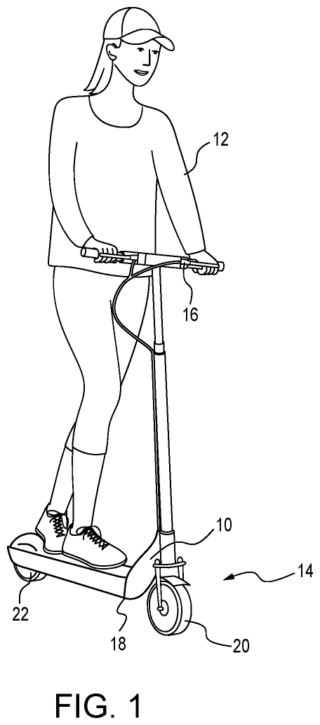

FIG. 1 illustrates a perspective view of a self-propelled scooter 10 for providing transportation for a rider 12 along a road 14. A scooter 10, sometimes called a kick scooter or a push scooter, traditionally includes a handlebar 16, a footboard 18, and front and rear wheels 20, 22 that is propelled by the rider 12 pushing off the road 14. A typical scooter 10 is most commonly made of aluminum, titanium, or steel. Some scooters 10, particularly those made for younger children, may have two front wheels 20 and/or two rear wheels 22, all of which are typically made of plastic or hardened rubber. In an alternate construction, a foldable aluminum scooter may include inline skates wheels.

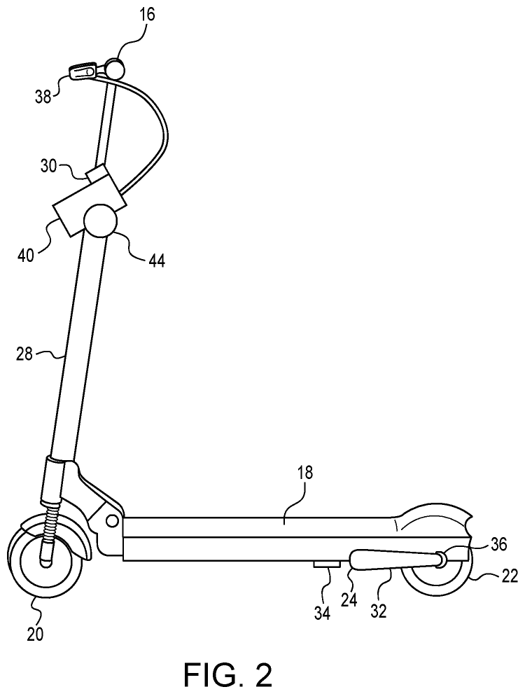

Further, the scooter 10 may be motorized. Motorized scooters may be powered by a gasoline engine, or, as illustrated in FIGS. 2-5, by an electric motor 24. A self-propelled scooter 10 may be capable of speeds up to 30 km/h (19 mph). A braking system 36 may also be applied in order to slow the scooter 10, particularly from the higher speeds capable with the application of the electric motor 24.

Continuing with reference to FIG. 1-5, the illustrated scooter 10 includes a front wheel 20, a rear wheel 22, and a footboard 18 extending longitudinally between the front wheel 20 and the rear wheel 22. An upright steering handle 28 attached to the front wheel 20 extends upward from the footboard 18. The upright steering handle 28 is topped by the handlebar 16, which is the point of contact for the rider 12 with the steering mechanism of the scooter 10.

The scooter 10 may also include a processor 30 for receiving instructions from the rider 12 of the scooter 10, through buttons or grips on the handlebar 16, for processing instructions to apply a driving force to the driven wheel, which in the illustrated embodiments is the rear wheel 22.

As the illustrated scooter 10 in FIG. 1 is a self-propelled scooter, the scooter 10 may further include an electric motor 24 for driving the rear wheel 22. The electric motor 24 may be a stand-alone electric motor that turns a shaft that is connected to the rear wheel 22 by a belt or chain 32 as illustrated in FIG. 2. Although not illustrated, the configuration could also be applied in the case of a gasoline motor.

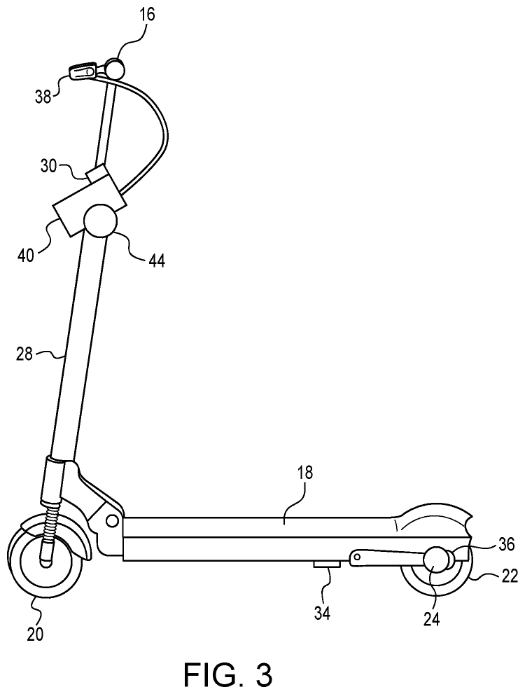

In an alternate embodiment, the electric motor 24 may be a brushless wheel hub motor integrated within the rear wheel 22 that turns the rear wheel 22 directly as illustrated in FIG. 3. Further, any other type of electric motor 24 and configuration known by a person of ordinary skill in the art may also be applied. In all the embodiments, the electric motor 24 is controlled by the processor 30 based on instructions from the rider 12.

Referring again to FIGS. 2-3, a battery 34 may be located beneath the footboard 18 in electrical communication with the electric motor 24 for supplying electricity to the electric motor 24. The battery 34 may be attached directly to the footboard 18 as illustrated, or housed within a container (not shown) that is attached to the footboard 18.

A braking system 36 for slowing rotation of the rear wheel 22 may also be attached beneath the footboard 18 and to the rear wheel 22. The braking system 36 may include an electromagnetic brake or an eddy current brake, both of which are well known to persons of ordinary skill in the art. Alternatively, the braking system 36 may be a regenerative braking system, which converts braking energy into electricity that is stored in the battery 34 for driving the electric motor 24. The braking system 36 is also controlled by the processor 30 based on instructions from the rider 12, who may apply the braking system 36 by gripping a brake grip 38 that is in electrical communication with the processor 30.

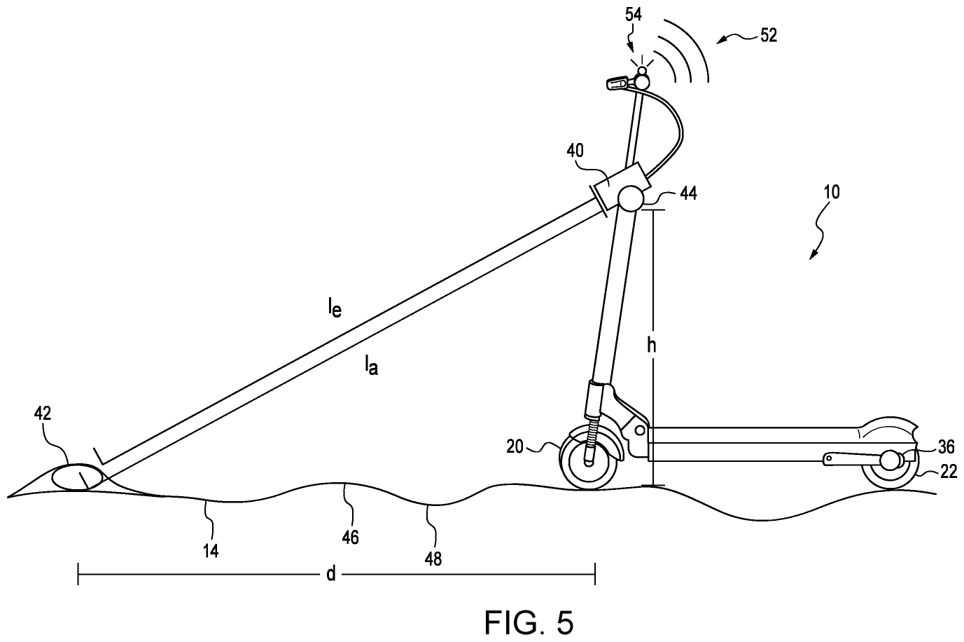

The scooter 10 further may include a first sensor 40 for detecting an obstacle 42 in the road 14 and a second sensor 44 for detecting vibrations of the scooter 10 along the road 14 caused by bumps 46 and ruts 48 in the road 14, as illustrated in FIG. 5.

The first sensor 40, in one embodiment, may be an ultrasonic sensor. Ultrasonic sensors emit a sound impulse and measure the elapsed time of the echo from an object. An ultrasonic sensor may sense most materials (metal, wood, plastic, glass, liquid, etc.) and is unaffected by color, transparency, shininess, or lighting conditions. Ultrasonic sensors may include discrete (object detection) and/or analog (distance sensing) outputs, in sensing distances up to 6000 mm.

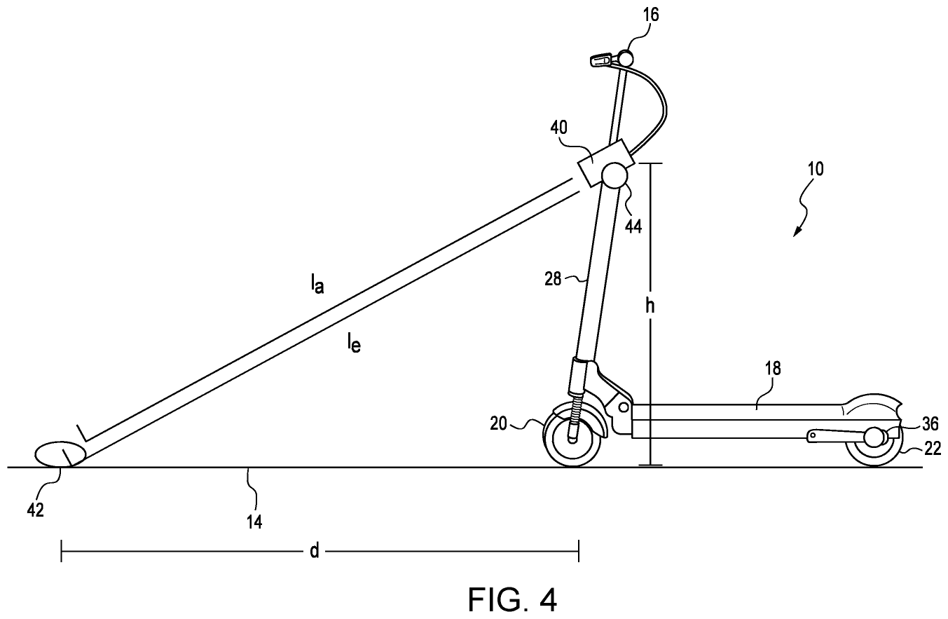

The first sensor 40 may be positioned to detect an expected distance lₑ in front of the scooter as illustrated in FIG. 5. lₑ may be calculated based on the height h of the first sensor 40 and the preset distance to the scanned area d, such that lₑ is calculated from the Pythagorean theorem, i.e. lₑ is the square root of the sum of h² and d². If an actual detected distance lₐ is greater than the expected distance lₑ, as illustrated in FIG. 5, then it may be presumed that the obstacle 42 located in the road 14 in front of the scooter 10 is a hole, such as a pothole. If the actual detected distance lₐ is less than the expected distance lₑ, as illustrated in FIG. 4, then it may be presumed the obstacle 42 present in the road 14 in front of the scooter 10 is an object, such as a rock.

However, the ability of the first sensor 40 to sense an accurate measure of the actual detected distance lₐ may be compromised by vertical displacement of the first sensor 40, such as displacement caused by vibrations imparted on the scooter 10 by unevenness in the road 14 caused by the bumps 46 and ruts 48 illustrated in FIG. 5. For example, a bump 46 may increase the height h of the first sensor 44, and a rut 48 may decrease the height h of the first sensor 40. A second sensor 44, such as an acceleration sensor, may also be included on the scooter 10, which is in communication with the processor 30 and capable of measuring increases or decreases in acceleration in three dimensions (along x-, y-, and z-axes). In addition to measuring acceleration, the acceleration measures may also be used to make corrections in the vertical displacement, upwardly or downwardly, of the scooter 10 by taking acceleration measurements over time in a method known to a person of ordinary skill in the art. The corrections based upon vertical displacement may be used to make corrections to the actual detected distance lₐ and/or the expected distance lₑ based on vertical movement of the scooter relative to, the obstacle 42 in the road 14 to create a corrected detected distance l_{c}.

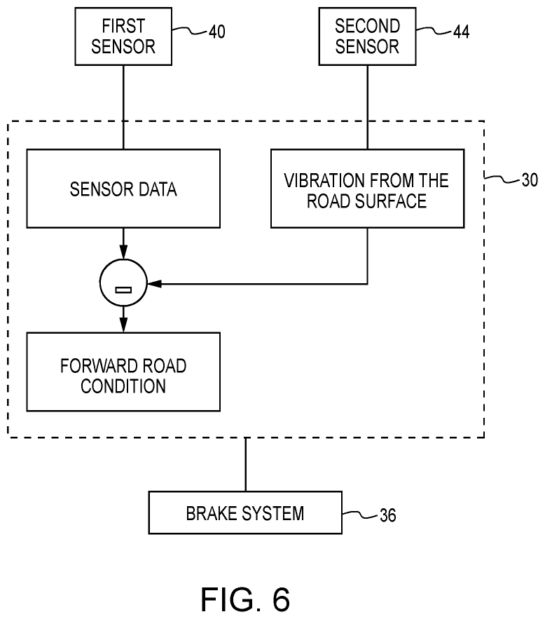

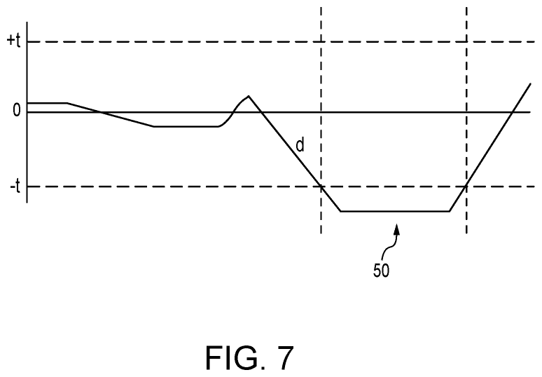

The processor 30, schematically illustrated in FIG. 6, which is in electrical communication with both the first sensor 40 and the second sensor 44, may be used to process corrected detected distance l_{c}, and to compare the corrected detected distance l_{c} to the expected distance lₑ. If the difference d between the corrected detected distance l_{c} and the expected distance lₑ exceeds a predetermined threshold t, plus +t or minus −t, as illustrated at the portion 50 of the difference d curve below the −t line in FIG. 7, the processor 30 may take action.

In one embodiment, the processor 30 may issue a warning to the rider 12 that, by detecting a difference d greater than the predetermined threshold, such that d>+t or d<−t, an obstacle 42, such as a hole or an obstruction is located in the road 12 forward of the scooter 10. Such a warning may be audible warning 52 played through a speaker in electrical communication with the processor 30, such as a beep, or a visual warning 54, such as a flashing red light on the scooter 10.

In another embodiment, the processor 30 may be in electrical communication with the braking system 36 that slows or stops the rotation of the driven wheel, whether the front wheel 20 or the rear wheel 22 as in the embodiment illustrated in FIGS. 2-5. When the threshold t is determined to be exceeded by the processor 30, the processor 30 may take control and apply the braking system 36 to slow or stop the scooter 10 to prevent hitting the obstacle 42 in front of the scooter 10. The processor 30 may also disengage the electric motor 24 to prevent the driven wheel from being rotated.

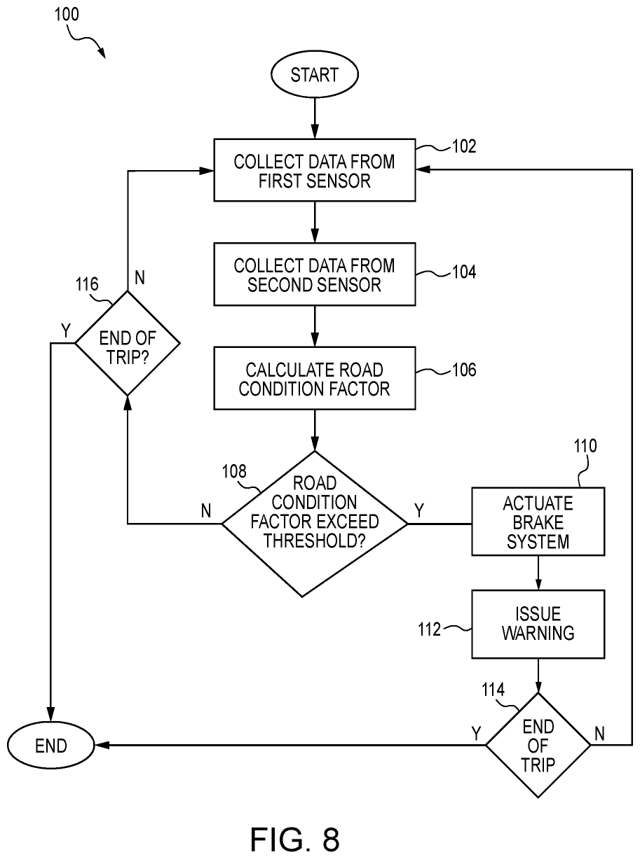

FIG. 8 is a flowchart illustrating a method 100 of actuating a braking system 36 of the scooter 10 traveling on a road 14. In the first step 102, data is collected from a first sensor 40, and in a second step 104, data is collected from a second sensor 44. In the third step 106, a road condition factor is calculated from data collected from the first and second sensors 40, 44. In the embodiments illustrated, the first sensor 40 may be an ultrasonic sensor for determining the actual detected distance lₐ to a location in front of the scooter 10. The second sensor 44 may be an acceleration sensor for making corrections to the actual detected distance lₐ to calculate the road condition factor, which in the illustrated embodiment is a difference d between a corrected detected distance l_{c} to the location in front of the scooter 10 and an expected distance lₑ.

The next step 108 of the method 100 is to determine whether the road condition factor exceeds a threshold level. The processor 30 attached to both the first sensor 40 and the second sensor 44 may be used to process the corrected detected distance l_{c}, and to compare the corrected detected distance l_{c} to the expected distance lₑ. If the difference d between the corrected detected distance l_{c} and the expected distance lₑ exceeds the predetermined threshold t, either positively +t or negatively −t, the processor 30 may take action.

The final step 110 of the method 100 is the processor taking the action of actuating the braking system 36 to slow the scooter 10 if the threshold level t is exceeded.

Additionally, the method 100 may include a step 112 of issuing a warning to a rider 12 of the scooter 10 in the form of an audible warning 52 through a speaker, bell, or other audio apparatus, or a visible warning 54 through a light source, such as a light emitting diode (LED) or a light bulb visible to the rider. Finally, the method 100 may include the steps 114, 116 of querying if the trip is complete to end the method 100.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

1. A scooter for providing transportation along a road, comprising:
a front wheel;
a rear wheel;
a footboard extending longitudinally between the front wheel and the rear wheel;
an upright steering handle attached to the front wheel;
a motor for driving the rear wheel;
a battery located beneath the footboard for supplying electricity to the motor;
an electromagnetic brake for slowing rotation of the rear wheel;
a first sensor for detecting an obstacle in the road; and
a second sensor for detecting vertical displacement of the scooter along the road.

2. The scooter of claim 1 further comprising a processor for:
collecting data from the first sensor;
collecting data from the second sensor;
calculating a road condition factor from data collected from the first sensor and the second sensor;
determining whether the road condition factor exceeds a threshold level; and
actuating the electromagnetic brake to slow the scooter if the threshold level is exceeded.

3. The scooter of claim 2 wherein:
the first sensor measures a first distance from the first sensor to a specified location in the road forward of the scooter; and
the second sensor measures a vertical displacement of the scooter due to the condition of the road beneath the first wheel.

4. The scooter of claim 3 wherein the first distance is compared to a expected distance defining a distance to a flat portion of a road forward of the scooter.

5. The scooter of claim 4 wherein the first distance is corrected based upon the vertical displacement of the scooter.

6. The scooter of claim 5 wherein the road condition factor is the difference between the first distance and the expected distance.

7. The scooter of claim 6 wherein the threshold level is a predetermined measure plus or minus the expected distance.

8. The scooter of claim 2 wherein a warning is issued to a rider of the scooter if the electromagnetic brake is actuated.

9. A method of actuating a braking system of a scooter traveling on a road, comprising the steps of:
measuring a first distance from a first sensor to a specified location in the road forward of the scooter;
measuring a vertical displacement of the scooter due to a condition of the road beneath the scooter using a second sensor;
comparing the first distance to a expected distance defining a distance to a flat portion of a road forward of the scooter;
correcting the first distance based upon the vertical displacement of the scooter;
calculating a road condition factor, wherein the road condition factor is the difference between the first distance and the expected distance;
determining whether the road condition factor exceeds a threshold level, wherein the threshold level is a predetermined measure plus or minus the expected distance; and
actuating the braking system to slow the scooter if the threshold level is exceeded.

10. A method of actuating a braking system of a scooter traveling on a road, comprising the steps of:
collecting data from a first sensor;
collecting data from a second sensor;
calculating a road condition factor from data collected from the first sensor and the second sensor;
determining whether the road condition factor exceeds a threshold level; and
actuating the braking system to slow the scooter if the threshold level is exceeded.

11. The method of claim 10, before actuating the braking system, further comprising the step of:
issuing a warning to a rider of the scooter.

12. The method of claim 11 wherein the warning is an audible warning.

13. The method of claim 11 wherein the warning is a visible warning.

14. The method of claim 10 wherein the road condition factor is a measurement of a distance.

15. The method of claim 14 wherein the first sensor measures a first distance from the first sensor to a specified location in the road forward of the scooter.

16. The method of claim 15 wherein the second sensor measures a vertical displacement of the scooter due to the condition of the road beneath the first wheel.

17. The method of claim 16 wherein the first distance is compared to a expected distance defining a distance to a flat portion of a road forward of the scooter.

18. The method of claim 17 wherein the first distance is corrected based upon the vertical displacement of the scooter.

19. The method of claim 18 wherein the road condition factor is the difference between the first distance and the expected distance.

20. The method of claim 19 wherein the threshold level is a predetermined measure plus or minus the expected distance.
